(19) United States
(12) Patent Application Publication
(10) Pub. No.: US 2022/0398169 A1
(43) Pub. Date: Dec. 15, 2022

(54) METHOD, SYSTEM AND COMPUTER-READABLE MEDIUM FOR SYNTHETIC INCREMENTAL DATA BACKUP

(71) Applicant: QNAP Systems, Inc., New Taipei City (TW)

(72) Inventors: Hsiao-Jung Lin, New Taipei City (TW); Wei-Tun Teng, New Taipei City (TW)

(21) Appl. No.: 17/558,657

(22) Filed: Dec. 22, 2021

Related U.S. Application Data
(60) Provisional application No. 63/209,408, filed on Jun. 11, 2021.

(30) Foreign Application Priority Data
Nov. 9, 2021 (TW) 110141665

(51) Int. Cl. G06F 11/14

(52) U.S. Cl. CPC G06F 11/1464; G06F 11/1469; G06F 11/1451; G06F 11/1435

(57) ABSTRACT

A method for synthetic incremental data backup, a corresponding system and a corresponding computer-readable medium are provided. The method is executed by a data device and a backup device and includes: generating an incremental backup data and an incremental block change record (BCR) of an N-th backup according to a current data of the data device of an M-th backup and a current data of the data device of the N-th backup, wherein N is an integer greater than or equal to three and M is a positive integer less than N; generating a synthetic backup data and a synthetic BCR of the N-th backup according to a synthetic backup data and a synthetic BCR of the M-th backup and the incremental backup data and the incremental BCR of the N-th backup; and storing the synthetic backup data and the synthetic BCR of the N-th backup in the backup device.

### BACKGROUND

### 1. Technical Field

The present disclosure relates to a data backup technology, and more particularly, to a method, system and computer-readable medium for synthetic incremental data backup that perform synthetic backup based on full backup and incremental backup.

### 2. Description of Related Art

With the advancement of data storage technology, the capacity of data storage devices such as hard disks continue to increase. Sometimes the storage space of a data storage device is divided into multiple data volumes for ease of use and management. For example, in the Microsoft Windows operating system, the storage space of a hard disk drive may be divided into multiple data volumes such as C drive (C:), D drive (D:) and E drive (E:). Among them, each data volume includes multiple blocks for storing data.

In order to avoid data damage caused by factors such as human negligence, virus damage, or hardware failure, users usually back up the data in the data volume on a regular basis. Currently, the commonly used data backup methods include full backup, incremental backup, and differential backup.

Full backup means that every backup transmits all the used blocks in the data volume to the server that provides data backup services. When there is the need to restore the data in the data volume, the previous backup data can be obtained from the server for restoration. However, if it is necessary to store the data of each previous full backup due to purposes such as version control, a lot of storage space is required.

In another aspect, incremental backup performs full backup only in the first backup. In each subsequent backup, only the blocks added or modified after the previous backup are sent to the server, instead of transmitting all used blocks. In this way, the storage space required for incremental backup is significantly less than that for full backup. However, for incremental backup, the data of each previous backup must be stored in order to be able to trace back the backup history to rebuild the original data when there is the need to restore the original data. Therefore, if the data of any one of the backups in the backup history is damaged, the original data cannot be rebuilt to make trouble for backup.

In still another aspect, differential backup only performs full backup in the first backup, and in each subsequent backup, the blocks added or modified after the first full backup are transmitted to the server. Therefore, only the data of the first full backup and the data of the last differential backup are needed to restore the original data in the data volume. However, the advantages and disadvantages of differential backup are between full backup and incremental backup.

### SUMMARY

In view of the aforementioned problems of the prior art, the present disclosure provides a synthetic incremental data backup method, provided in a synthetic incremental data backup system including a data device and a backup device, the method including the steps of: performing an incremental backup by the data device according to current data of the data device of an M-th backup and an N-th backup to generate incremental backup data and an incremental block change record of the N-th backup; generating a synthetic block change record of the N-th backup by the data device according to a synthetic block change record of the M-th backup and the incremental block change record of the N-th backup; generating synthetic backup data of the N-th backup by the backup device according to synthetic backup data of the M-th backup, the incremental backup data of the N-th backup, the synthetic block change record of the M-th backup, and the incremental block change record of the N-th backup; and having the system store the synthetic backup data and the synthetic block change record of the N-th backup in the backup device.

The present disclosure also provides a computer-readable medium used in a synthetic incremental data backup system including a data device and a backup device. The computer-readable medium stores instructions for executing the aforementioned synthetic incremental data backup method.

The present disclosure further provides a synthetic incremental data backup system, including a data device and a backup device. The data device is configured for performing an incremental backup according to current data of the data device of an M-th backup and an N-th backup to generate incremental backup data and an incremental block change record of the N-th backup. The backup device is configured for storing synthetic backup data and a synthetic block change record of the N-th backup. The synthetic block change record of the N-th backup is generated by the backup device according to a synthetic block change record of the M-th backup and the incremental block change record of the N-th backup. The synthetic backup data of the N-th backup is generated by the backup device according to synthetic backup data of the M-th backup, the incremental backup data of the N-th backup, the synthetic block change record of the M-th backup, and the incremental block change record of the N-th backup.

The storage space required by the method and the synthetic incremental data backup system provided by the present disclosure is less than that required by full backup. The method and the system of the present disclosure do not need to trace back through the entire backup history to restore data like incremental backup, and are more efficient than differential backup.

### BRIEF DESCRIPTION OF THE DRAWINGS

The present disclosure can be more fully understood by reading the following descriptions of the embodiments, with reference made to the accompanying drawings.

FIG. 1 is a block diagram of a synthetic incremental data backup system according to an embodiment of the present disclosure.

FIG. 2 is a schematic flowchart of a synthetic incremental data backup method according to an embodiment of the present disclosure.

FIG. 3 is a schematic flowchart of a process of generating block hash values in the synthetic incremental data backup method in FIG. 2.

FIG. 4 is a schematic diagram of an illustrative synthetic backup in the synthetic incremental data backup method in FIG. 2.

FIG. 5 is a schematic diagram of deduplication in the synthetic incremental data backup method in FIG. 2.

FIGS. 6 and 7 are schematic diagrams of failures of synthetic backup in the synthetic incremental data backup method in FIG. 2.

FIGS. 8 to 10 are schematic diagrams of data restoration in the synthetic incremental data backup method in FIG. 2.

FIG. 11 is a schematic diagram of an illustrative data restoration in the synthetic incremental data backup method in FIG. 2.

### DETAILED DESCRIPTION OF THE EMBODIMENTS

The following specific embodiments are used for illustrating the implementation of the present disclosure. A person skilled in the art can easily understand the other advantages and effects of the present disclosure based on the disclosure of the specification.

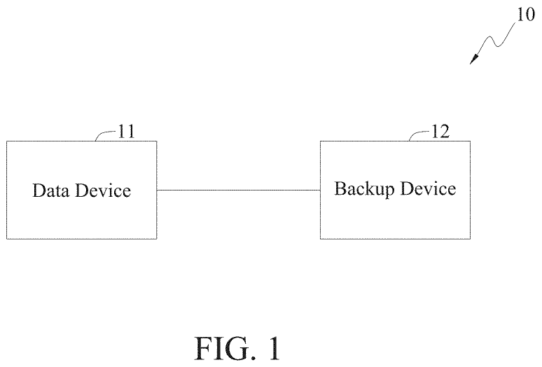

FIG. 1 is a block diagram of a synthetic incremental data backup system 10 according to an embodiment of the present disclosure. The synthetic incremental data backup system 10 includes a data device 11 and a backup device 12, wherein the data device 11 and the backup device 12 may be connected by a wired or wireless connection for transmitting data to each other.

In an embodiment, the data device 11 may be a smart phone, a computer, a server, or an electronic device of any other type with data processing functions. The backup device 12 may be a smart phone, a computer, a server, a network attached storage (NAS), or an electronic device of any other type with data storage functions.

In an embodiment, the data device 11 includes at least one data storage device, and the at least one data storage device includes at least one data volume, such as a data volume of the Microsoft Windows operating system. The data volume includes a plurality of blocks, and the backup device 12 may provide services of data backup and data restoration for the data volume.

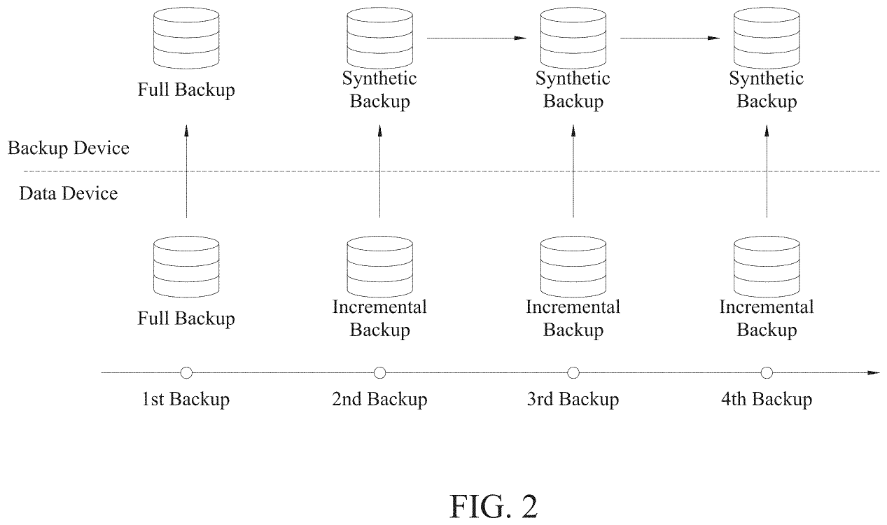

FIG. 2 is a schematic flowchart of a synthetic incremental data backup method according to an embodiment of the present disclosure. The synthetic incremental data backup method may be executed cooperatively by the data device 11 and the backup device 12 of the synthetic incremental data backup system 10 shown in FIG. 1.

First, in the first backup, the data device 11 performs a full backup of the current data in the data volume. The current data is a set comprised of all used blocks in the data volume. The full backup combines all the used blocks in the data volume into full backup data, and then transmits the full backup data to the backup device 12. The backup device 12 receives the full backup data from the data device 11 to store the full backup data in the backup device 12.

Then, in the second backup, the data device 11 performs incremental backup of the current data in the data volume to generate the incremental backup data I-DATA₂ and the incremental block change record I-BCR₂ of the second backup, and then transmit the incremental backup data I-DATA₂ and the incremental block change record I-BCR₂ of the second backup to the backup device 12.

The incremental block change record I-BCR₂ of the second backup is generated by comparing the hash value of each block in the current data of the first backup and the hash value of each block in the current data of the second backup (details described later). The incremental block change record I-BCR₂ of the second backup includes the record of changes such as addition, modification, and deletion of the blocks in the data volume between the first backup and the second backup.

The incremental backup data I-DATA₂ of the second backup includes all added blocks and all modified blocks in the incremental block change record I-BCR₂ of the second backup. In other words, I-DATA₂ includes all blocks that are added or modified between the first backup and the second backup.

The backup device 12 receives the incremental backup data I-DATA₂ and the incremental block change record I-BCR₂ of the second backup from the data device 11, uses the incremental backup data I-DATA₂ and the incremental block change record I-BCR₂ of the second backup as the synthetic backup data S-DATA₂ and the synthetic block change record S-BCR₂ of the second backup, and stores the synthetic backup data S-DATA₂ and the synthetic block change record S-BCR₂ of the second backup in the backup device 12.

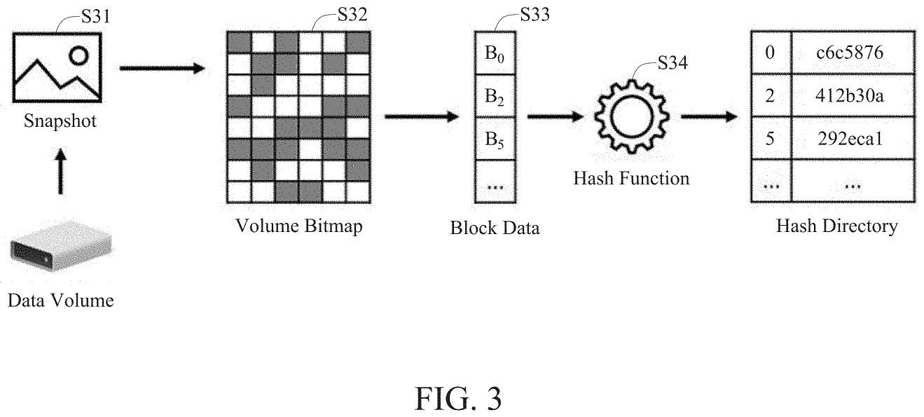

FIG. 3 is a schematic flowchart of the process of generating block hash values in the synthetic incremental data backup method in FIG. 2. In each backup, the data device 11 can generate the hash value of each block of the current data according to this process.

First, in step S31, generate a snapshot of the data volume. The snapshot may also be referred as shadow copy. Next, the flow proceeds to step S32.

In step S32, read the volume bitmap of the data volume from the snapshot. Each block of the data volume corresponds to a bit in the volume bitmap, and the bit indicates whether the corresponding block has been used or not. Next, the flow proceeds to step S33.

In step S33, read the data of all used blocks in the data volume according to the volume bitmap. In the embodiment shown in FIG. 3, the volume bitmap indicates that blocks B₀, B₂ and B₅ have been used, therefore the data of blocks B₀, B₂ and B₅ are read. It is unnecessary to read the unused blocks. Next, the flow proceeds to step S34.

In step S34, use a preset hash function (for example, SHA-256) to calculate a hash value of the data of each used block in the data volume and thereby generate a hash directory. For each block of the current data, the hash directory includes the number of the block and the hash value of the data of the block. For example, as shown in FIG. 3, the hash value of the data of block B₀ is c6c5876 (hexadecimal value), and so on.

The data device 11 generates and stores a hash directory of the current data in each backup. Also in each backup, the data device 11 can know which blocks in the data volume are added, modified or deleted between the current backup and the previous backup by comparing the hash directories of the current backup and the previous backup. In addition, the data device 11 can generate the incremental block change record of the current backup based on the aforementioned comparing of the hash directories.

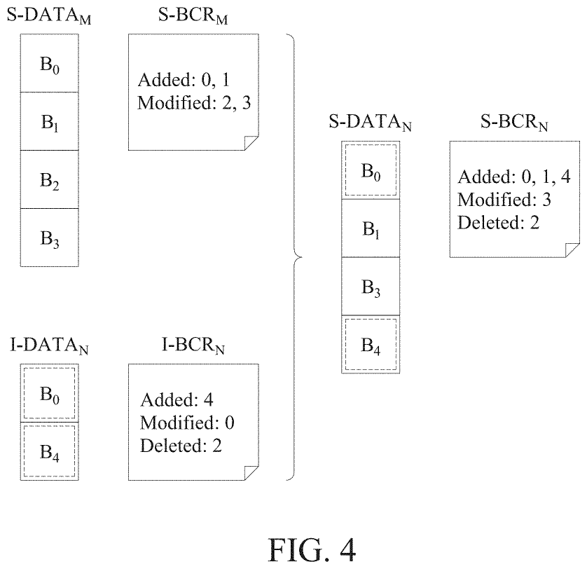

Next, please refer to FIG. 2 and FIG. 4. In the third backup and each subsequent backup (hereinafter referred to as the N-th backup, and N is an integer greater than or equal to three), the data device 11 performs incremental backup based on the current data of the previous M-th backup (M is a positive integer less than N, if the last backup before the N-th backup has no data damage, then M is equal to N−1) and the current data of the N-th backup, thereby generates the incremental backup data I-DATA_{N} and the incremental block change record I-BCR_{N} of the N-th backup, and then transmits the incremental backup data I-DATA_{N} and the incremental block change record I-BCR_{N} of the N-th backup to the backup device 12.

The incremental block change record I-BCR_{N} of the N-th backup is generated by comparing the hash value of each block of the current data of the M-th backup and the hash value of each block of the current data of the N-th backup. Further, the incremental block change record I-BCR_{N} of the N-th backup includes the record of changes such as addition, modification, and deletion of the blocks in the data volume between the M-th backup and the N-th backup.

The incremental backup data I-DATA_{N} of the N-th backup includes all added blocks and all modified blocks in the incremental block change record I-BCR_{N} of the N-th backup.

Next, the backup device 12 receives the incremental backup data I-DATA_{N} and the incremental block change record I-BCR_{N} for the N-th backup from the data device 11, and performs a synthetic backup. The synthetic backup includes generating the synthetic block change record S-BCR_{N} of the N-th backup according to the synthetic block change record S-BCR_{M} of the M-th backup and the incremental block change record I-BCR_{N} of the N-th backup. The synthetic backup also includes generating the synthetic backup data S-DATA_{N} of the N-th backup according to the synthetic backup data S-DATA_{M} of the M-th backup, the incremental backup data I-DATA_{N} of the N-th backup, the synthetic block change record S-BCR_{M} of the M-th backup, and the incremental block change record I-BCR_{N} of the N-th backup. The synthetic backup further includes storing S-DATA_{N} and S-BCR_{N} in the backup device 12. The present disclosure does not limit the relative order of the generation of S-DATA_{N} and S-BCR_{N}. In different embodiments, the backup device 12 may generate S-DATA_{N} first and then generate S-BCR_{N}, or generate S-BCR_{N} first and then generate S-DATA_{N}.

The synthetic block change record S-BCR_{M} of the M-th backup includes the record of changes such as addition, modification and deletion of the blocks in the data volume of the data device 11 between the previous full backup (for example, the first backup in this embodiment) and the M-th backup. In the embodiment shown in FIG. 4, S-BCR_{M} records that, between the previous full backup and the M-th backup, blocks B₀ and B₁ are added, and blocks B₂ and B₃ are modified.

The incremental block change record I-BCR_{N} of the N-th backup includes the record of changes such as addition, modification and deletion of the blocks in the data volume between the M-th backup and the N-th backup. In the embodiment shown in FIG. 4, I-BCR_{N} records that, between the M-th backup and the N-th backup, block B₄ is added, block B₀ is modified, and block B₂ is deleted.

The synthetic block change record S-BCR_{N} of the N-th backup is the block change record obtained by merging the incremental block change record I-BCR_{N} of the N-th backup into the synthetic block change record S-BCR_{M} of the M-th backup. Therefore, the synthetic block change record S-BCR_{N} of the N backup includes the record of changes such as addition, modification, and deletion of blocks in the data volume between the previous full backup and the N-th backup. In the embodiment shown in FIG. 4, S-BCR_{N} records that, between the previous full backup and the N-th backup, blocks B₀, B₁, and B₄ are added, block B₃ is modified, and block B₂ is deleted.

The synthetic backup data S-DATA_{N} of the N-th backup includes all added blocks and all modified blocks in the synthetic block change record S-BCR_{N} of the N-th backup. In other words, S-DATA_{N} includes all the blocks that are added or modified between the previous full backup and the N-th backup. In the embodiment shown in FIG. 4, S-DATA_{N} includes the added blocks B₀, B₁, B₄ and the modified block B₃ recorded in S-BCR_{N}. Among them, blocks B₁ and B₃ are from S-DATA_{M}, while blocks B₀ and B₄ are from I-DATA_{N}.

FIG. 4 shows the generation rules of S-DATA_{N}. In detail, for each block recorded as added or modified in S-BCR_{N}, if the block is included in I-DATA_{N}, the block is copied from I-DATA_{N} to S-DATA_{N}, otherwise the block is copied from S-DATA_{M} to S-DATA_{N}. In addition, the blocks recorded as deleted in S-BCR_{N} are not copied to S-DATA_{N}.

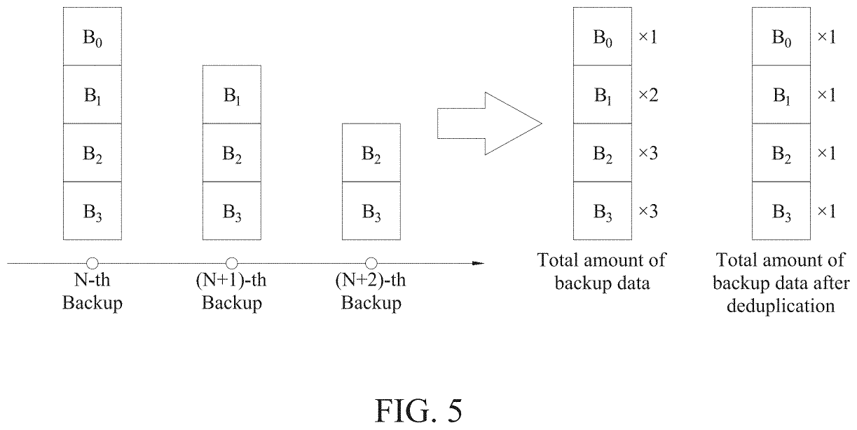

After each backup, the backup device 12 may perform deduplication on the full backup data and the synthetic backup data of each previous backup stored in the backup device 12 to save storage space. In an embodiment shown in FIG. 5, the synthetic backup data S-DATA_{N} generated by the backup device 12 in the N-th backup includes blocks B₀-B₃. Before the (N+1)-th backup, block B₀ is deleted, so the synthetic backup data S-DATA_{N+1} generated by the backup device 12 in the (N+1)-th backup includes only blocks B₁-B₃. Before the (N+2)-th backup, block B₁ is deleted, so the synthetic backup data S-DATA_{N+2} generated by the backup device 12 in the (N+2)-th backup includes only blocks B₂ and B₃. In order to store the synthetic backup data of the three backups, the backup device 12 needs to store one copy of block B₀, two copies of block B 1, three copies of block B₂, and three copies of block B₃, which requires a total of 9 blocks of storage space.

After the deduplication is performed, only one copy of each block B₀-B₃ needs to be stored. For example, the backup device 12 only stores blocks B₀-B₃ of S-DATA_{N}. Blocks B₁-B₃ of S-DATA_{N+1} can be respectively replaced by pointers to blocks B₁-B₃ of S-DATA_{N}. Blocks B₂ and B₃ of S-DATA_{N+2} can be respectively replaced by pointers to blocks B₂ and B₃ of S-DATA_{N}. Thereby, only a total of 4 blocks of storage space is required, which greatly reduces the requirement for the storage space of the backup device 12.

In addition, if the hash directory of a backup stored in the data device 11 is accidentally damaged and consequently the next backup cannot be performed, or if the full backup data or the synthetic backup data of the backup stored in the backup device 12 is accidentally damaged and consequently the next backup cannot be performed and the current data of the data device 11 of the backup cannot be restored, the backup is regarded as a failure. Conversely, if the aforementioned data damage does not occur, the backup is regarded as a success. For an unexpected event of backup failure, there are the following two options for handling the event.

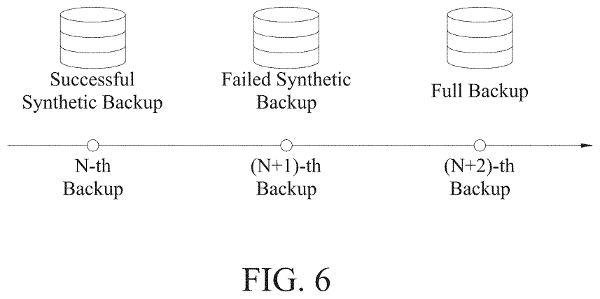

The first option is performing a full backup in the next backup of a failed backup. For example, as shown in FIG. 6, the (N+1)-th backup fails. Therefore, a full backup instead of a synthetic backup is performed in the (N+2)-th backup, which is the same as the first backup shown in FIG. 2. The subsequent (N+3)-th and (N+4)-th backups are respectively the same as the second and third backups shown in FIG. 2, and so on.

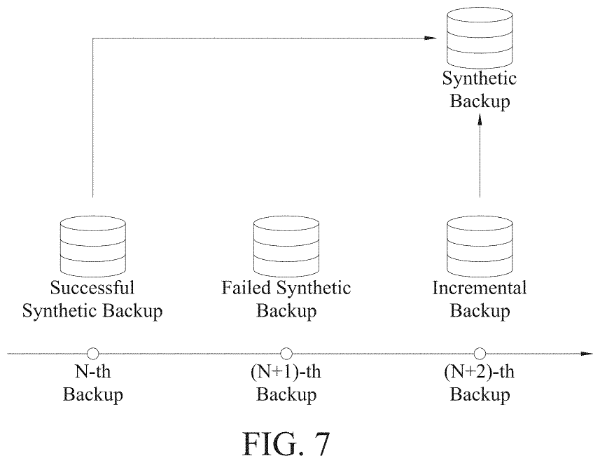

The second option is that when the previous backup fails, the full backup data or the synthetic backup data of the previous backup is not used for the current synthetic backup. Instead, the full backup data or the synthetic backup data of the last successful backup is used for the current synthetic backup. For example, as shown in FIG. 7, the (N+1)-th backup fails. Therefore, in the (N+2)-th backup, the synthetic backup data of the (N+1)-th backup is not used for the current synthetic backup. Instead, the synthetic backup of the N-th backup is used for the current synthetic backup. For another example, in the embodiment shown in FIG. 4, if the data of the (N−1)-th backup is not damaged, then the M-th backup in FIG. 4 is the (N−1)-th backup. Otherwise, the M-th backup is the last successful backup before the N-th backup. That is, the M-th backup is the last backup without data damage.

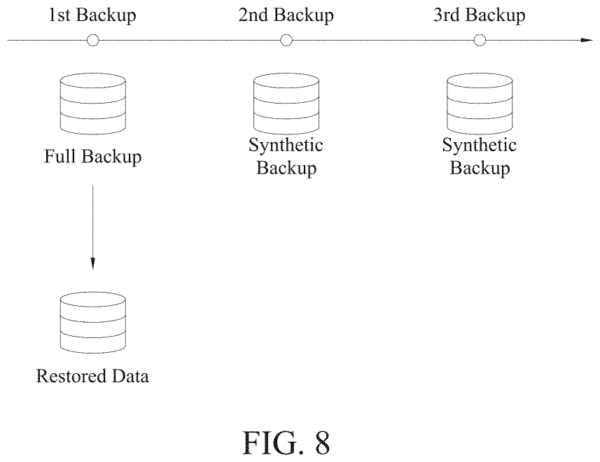

Next, please refer to FIGS. 8-10, which are schematic diagrams of data restoration in the synthetic incremental data backup method in FIG. 2.

When it is necessary to restore the current data of data device 11 of the first backup, as shown in FIG. 8, the backup device 12 may directly transmit the full backup data of the first backup to the data device 11 so that the data device 11 can restore the current data in its data volume.

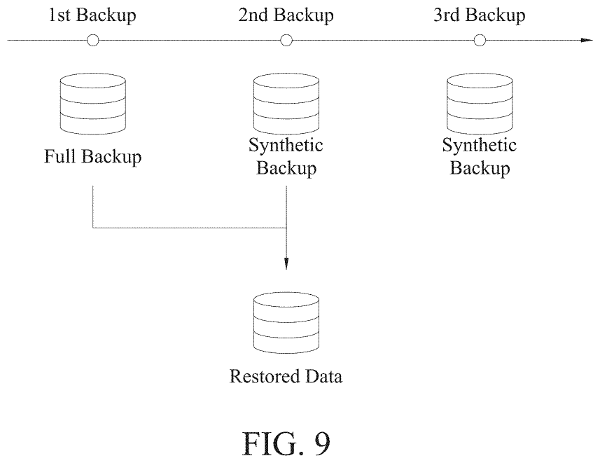

When it is necessary to restore the current data of the data device 11 of the second backup, as shown in FIG. 9, the backup device 12 restores the current data of the second backup according to the full backup data of the first backup and the synthetic backup data and the synthetic block change record of the second backup, and then transmits the current data of the second backup to the data device 11 so that the data device 11 can restore the current data in its data volume.

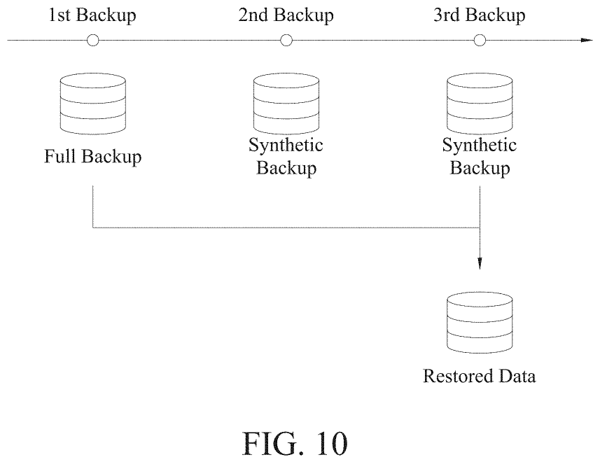

When it is necessary to restore the current data of the data device 11 of the third backup, as shown in FIG. 10, the backup device 12 restores the current data of the third backup according to the full backup data of the first backup and the synthetic backup data and the synthetic block change record of the third backup, and then transmits the current data of the third backup to the data device 11 so that the data device 11 can restore the current data in its data volume.

In view of the importance of the full backup data, in an embodiment, the backup device 12 may duplicate the full backup data of the first backup into at least two copies and store them in the backup device 12. When it is necessary to restore the current data of the data device 11 of a subsequent backup, the backup device 12 first checks whether the copies of the full backup data are damaged, and then restores the current data of the subsequent backup according to an undamaged copy of the full backup data.

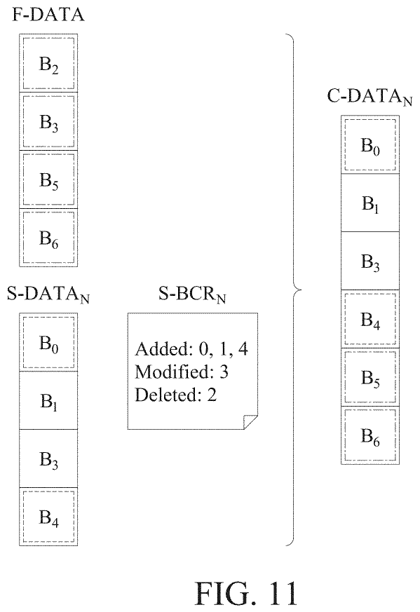

Please refer to FIG. 11, which is a schematic diagram of an illustrative data restoration in the synthetic incremental data backup method in FIG. 2. The example in FIG. 11 corresponds to the example in FIG. 4. As shown in FIG. 11, when it is necessary to restore the current data C-DATA_{N} of the data device 11 of the N-th backup (N is an integer greater than or equal to three), the backup device 12 restores the current data C-DATA_{N} of the N-th backup according to the full backup data F-DATA of the first backup and the synthetic backup data S-DATA_{N} and the synthetic block change record S-BCR_{N} of the N-th backup, and then transmit the current data C-DATA_{N} of the N-th backup to the data device 11 so that the data device 11 can restore the current data in its data volume.

FIG. 11 shows the rules for generating C-DATA_{N}. In detail, the blocks recorded as added or modified in S-BCR_{N} are copied from S-DATA_{N} to C-DATA_{N}, and the blocks included in F-DATA and not included in S-DATA_{N} and not recorded as deleted in S-BCR_{N} are copied from F-DATA to C-DATA_{N}. In addition, the blocks recorded as deleted in S-BCR_{N} are not copied to C-DATA_{N}. In the embodiment shown in FIG. 11, blocks B₀, B₁, B₃ and B₄ in C-DATA_{N} are from S-DATA_{N}, while blocks B₅ and B₆ in C-DATA_{N} are from F-DATA.

The present disclosure is not limited to the aforementioned system and synthetic incremental data backup method. In an embodiment, the present disclosure further provides a computer-readable medium, such as a memory, floppy disk, hard disk or optical disk. The computer-readable medium can be applied in the backup device 12 and stores instructions for controlling the backup device 12 to execute the aforementioned synthetic incremental data backup method.

In summary, the method, system and computer-readable medium for synthetic incremental data backup provided by the present disclosure only need to store the blocks added or modified after the full backup in subsequent backups of the first full backup. Therefore, the storage space required is less than that of conventional full backup.

In addition, the method, system and computer-readable medium for synthetic incremental data backup provided by the present disclosure need only the full backup data of the first backup and the synthetic backup data of a subsequent backup for restoring the current data of the subsequent backup without having to trace back the entire backup history. Hence, the method, system and computer-readable medium provided by the present disclosure have higher efficiency and damage tolerance than conventional incremental backup do.

Moreover, the method, system and computer-readable medium for synthetic incremental data backup provided by the present disclosure only need to extract the incremental data relative to the previous backup, and do not need to extract the differential data relative to the previous full backup. Therefore, the amount of extracted data is much smaller than that of differential backup. The difference between the present disclosure and differential backup is that the present disclosure performs incremental backup based on the data difference between the first full backup and the current backup. Therefore, the synthetic incremental data backup method provided by the present disclosure is more efficient than conventional differential backup.

Further, the method, system and computer-readable medium for synthetic incremental data backup provided by the present disclosure adopt block-level data backup and data restoration. Therefore, their performance is better than that of conventional file-level data backup and data restoration.

Besides, the method, system and computer-readable medium for synthetic incremental data backup provided by the present disclosure can achieve application-consistent backup through the Volume Shadow Copy Service of the Microsoft Windows operating system. In other words, the method, system and computer-readable medium for synthetic incremental data backup provided by the present disclosure can freeze disk operations of applications and then perform data backup to ensure that the applications can resume their normal execution after data restoration. Therefore, the present disclosure is better than conventional crash-consistent backup.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A method for synthetic incremental data backup, applicable to a synthetic incremental data backup system comprising a data device and a backup device, the method comprising:
performing an incremental backup by the data device according to current data of the data device of an M-th backup and an N-th backup to generate incremental backup data and an incremental block change record of the N-th backup;
generating a synthetic block change record of the N-th backup by the backup device according to a synthetic block change record of the M-th backup and the incremental block change record of the N-th backup;
generating synthetic backup data of the N-th backup by the backup device according to synthetic backup data of the M-th backup, the incremental backup data of the N-th backup, the synthetic block change record of the M-th backup, and the incremental block change record of the N-th backup; and
having the system store the synthetic backup data and the synthetic block change record of the N-th backup in the backup device.

2. The method according to claim 1, wherein,
N is an integer greater than or equal to three,
M is a positive integer less than N, and
the M-th backup is a latest backup without data damage before the N-th backup.

3. The method according to claim 1, wherein,
the synthetic block change record of the M-th backup comprises a record of changes of blocks in a data volume of the data device between a previous full backup and the M-th backup,
the incremental block change record of the N-th backup comprises a record of changes of the blocks in the data volume between the M-th backup and the N-th backup, and
the synthetic block change record of the N-th backup comprises a record of changes of the blocks in the data volume between the previous full backup and the N-th backup.

4. The method according to claim 1, wherein,
the incremental block change record of the N-th backup is generated by comparing hash values of blocks in the current data of the M-th backup with hash values of blocks in the current data of the N-th backup, and
the incremental backup data of the N-th backup comprises all added blocks and all modified blocks in the incremental block change record of the N-th backup.

5. The method according to claim 1, further comprising:
having the backup device receive full backup data of a previous full backup from the data device and store the full backup data in the backup device, wherein the full backup data comprises all used blocks in a data volume of the data device.

6. The method according to claim 5, further comprising:
having the backup device receive incremental backup data and an incremental block change record of a next backup of the previous full backup from the data device and store the incremental backup data and the incremental block change record of the next backup in the backup device, wherein the incremental backup data and the incremental block change record of the next backup directly serve as synthetic backup data and a synthetic block change record of the next backup.

7. The method according to claim 5, further comprising:
having the backup device perform deduplication on the full backup data and the synthetic backup data of all previous backups stored in the backup device.

8. The method according to claim 5, further comprising:
having the backup device restore the current data of the N-th backup according to the full backup data, the synthetic backup data of the N-th backup, and the synthetic block change record of the N-th backup; and
having the backup device transmit the restored current data of the N-th backup to the data device.

9. The method according to claim 5, further comprising:
having the backup device duplicate the full backup data into at least two copies and store the at least two copies in the backup device;
having the backup device restore the current data of the N-th backup according to an undamaged one of the at least two copies; and
having the backup device transmit the restored current data of the N-th backup to the data device.

10. A computer-readable medium used in a synthetic incremental data backup system comprising a data device and a backup device, the computer-readable medium storing instructions for executing a method for synthetic incremental data backup, the method comprising:
performing an incremental backup by the data device according to current data of the data device of an M-th backup and an N-th backup to generate incremental backup data and an incremental block change record of the N-th backup;
generating a synthetic block change record of the N-th backup by the backup device according to a synthetic block change record of the M-th backup and the incremental block change record of the N-th backup;
generating synthetic backup data of the N-th backup by the backup device according to synthetic backup data of the M-th backup, the incremental backup data of the N-th backup, the synthetic block change record of the M-th backup, and the incremental block change record of the N-th backup; and
having the system store the synthetic backup data and the synthetic block change record of the N-th backup in the backup device.

11. A system for synthetic incremental data backup, comprising:
a data device, configured for performing an incremental backup according to current data of the data device of an M-th backup and an N-th backup to generate incremental backup data and an incremental block change record of the N-th backup; and
a backup device, configured for storing synthetic backup data and a synthetic block change record of the N-th backup, wherein,
the synthetic block change record of the N-th backup is generated by the backup device according to a synthetic block change record of the M-th backup and the incremental block change record of the N-th backup, and
the synthetic backup data of the N-th backup is generated by the backup device according to synthetic backup data of the M-th backup, the incremental backup data of the N-th backup, the synthetic block change record of the M-th backup, and the incremental block change record of the N-th backup.

12. The system according to claim 11, wherein,
N is an integer greater than or equal to three,
M is a positive integer less than N, and
the M-th backup is a latest backup without data damage before the N-th backup.

13. The system according to claim 11, wherein,
the synthetic block change record of the M-th backup comprises a record of changes of blocks in a data volume of the data device between a previous full backup and the M-th backup,
the incremental block change record of the N-th backup comprises a record of changes of the blocks in the data volume between the M-th backup and the N-th backup, and
the synthetic block change record of the N-th backup comprises a record of changes of the blocks in the data volume between the previous full backup and the N-th backup.

14. The system according to claim 11, wherein,
the incremental block change record of the N-th backup is generated by comparing hash values of blocks in the current data of the M-th backup with hash values of blocks in the current data of the N-th backup, and
the incremental backup data of the N-th backup comprises all added blocks and all modified blocks in the incremental block change record of the N-th backup.

15. The system according to claim 11, wherein,
the backup device is further configured for receiving full backup data of a previous full backup from the data device and storing the full backup data in the backup device, and
the full backup data comprises all used blocks in a data volume of the data device.
